(19) United States
(12) Patent Application Publication
(10) Pub. No.: US 2012/0033888 A1
(43) Pub. Date: Feb. 9, 2012

(54) IMAGE PROCESSING SYSTEM, IMAGE PROCESSING METHOD, AND COMPUTER READABLE MEDIUM

(76) Inventor: Tetsuya TAKAMORI, (US)

(21) Appl. No.: 12/852,943

(22) Filed: Aug. 9, 2010

(51) Int. Cl. G06K 9/46

(52) U.S. Cl. 382/190

(57) ABSTRACT

Provided is an image processing system for correcting an optical response of an image capturing optical system with low cost. The image processing system includes: a feature value extracting section that extracts feature values from each of images captured in different positions of a plurality of captured images captured by an image capturing apparatus; and an image processing section that, based on feature values extracted by the feature value extracting section, generates a corrected image in which difference in optical response for each image region caused by an image capturing optical system, from the captured image captured by the image capturing apparatus or other captured images.

### BACKGROUND

1. Technical Field

The present invention relates to an image processing system, an image processing method, and a computer readable medium. The contents of the following patent application is incorporated herein by reference, No. 2009-200691 filed on Aug. 31, 2009.

2. Description of the Related Art

Conventionally, an image capturing apparatus for adjusting an image using corrective data corresponding to a combination of the distance between the image capturing optical system and the subject and the focal length (e.g., Patent Document No. 1). The image capturing apparatus detects the distance up to the subject, detects the focal length of the image capturing optical system, reads the corrective data corresponding to the detected distance and focal length, and correct the object image using the read corrective data.
Patent Document No. 1: Japanese Patent Application Publication No. H9-74514

### SUMMARY

The technology according to Patent Document No. 1 can recover a deteriorated image using the corrective data corresponding to the distance up to the subject and the focal length. However, according to the technology of Patent Document No. 1, the image capturing apparatus should include a device for detecting the distance up to the subject and the focal length at the time of image capturing, which incurs cost increase compared to image capturing apparatuses that do not detect these types of information. Various possible factors can be considered which deteriorate images, e.g., focus position, zoom position, diaphragm position, and the distance up to the subject. Cost will greatly increase if attempting to correct deteriorated images with high accuracy taking into consideration these various factors of deterioration.

So as to solve the stated problems, according to a first aspect of the innovations herein, provided is an image processing system including: a feature value extracting section that extracts feature values respectively from images captured in different positions of a plurality of captured images captured by an image capturing apparatus; a corrective data calculating section that calculates, from images of a same subject captured in different positions of the plurality of captured images captured by the image capturing apparatus, corrective data for correcting a difference in optical response for each image region caused by an image capturing optical system of the image capturing apparatus; and an image processing section that, based on feature values respectively extracted from images captured in different positions of a captured image and by using the corrective data, corrects the captured image for a difference in optical response for each image region caused by an image capturing optical system used in capturing the captured image, so as to generate a corrected image in which the difference in optical response for each image region caused by the image capturing optical system has been corrected.

The image processing section may correct, based on the feature values respectively extracted by the feature value extracting section and by using the corrective data, a captured image captured by the image capturing apparatus for a difference in optical response for each image region caused by the image capturing optical system of the image capturing apparatus, so as to generate a corrected image in which the difference in optical response for each image region caused by the image capturing optical system of the image capturing apparatus has been corrected.

The image processing section may generate the corrected image based on the feature values extracted by the feature value extracting section and a position of the same subject on the plurality of captured images.

The image processing system may further include: a corrective data storage section that stores the corrective data in association with the feature values extracted from images captured in different positions, where the image processing section generates the corrected image, by using the corrective data stored in the corrective data storage section in association with feature values matching the feature values extracted from the captured image captured by the image capturing apparatus.

The corrective data calculating section may calculate corrective data for correcting a difference in optical response for each image region caused by an image capturing optical system of a different image capturing apparatus different from the image capturing apparatus, from images of a same subject captured in different positions of a plurality of captured images captured by the different image capturing apparatus, by using one of the images of the same subject as a correct image by giving higher priority to an image positioned nearer to a center of the captured images, and the image processing section may generate the corrected image, by using the corrective data stored in the corrective data storage section in association with the feature values matching the feature values extracted from the captured image captured by the image capturing apparatus.

The corrective data calculating section may calculate the corrective data by performing processing at least using a plurality of captured images captured by the different image capturing apparatus under a plurality of respectively different image capturing conditions.

The corrective data calculating section may calculate the corrective data by performing processing at least using a plurality of captured images of subjects having respectively different distances in an optical axial direction captured by the different image capturing apparatus.

The image processing section may generate the corrected image by using the corrective data for correcting a shape of a subject image.

The feature value extracting section may extract the feature values including edge information, from images of a same subject captured in different positions of the plurality of captured images captured by the image capturing apparatus.

The image processing section may generate the corrected image by using the corrective data for correcting blurring of a subject image.

The feature value extracting section extracts the feature values including a spatial frequency component, from images of a same subject captured in different positions of the plurality of captured images captured by the image capturing apparatus.

The corrective data may include a high frequency component to be added to the subject image, and the image processing section may generate the corrected image by adding, to an image, the high frequency component included in the corrective data.

The corrective data may include an image filter to be applied to the subject image, and the image processing section may generate the corrected image by applying, to an image, the image filter included in the corrective data.

The image processing section may generate the corrected image by using the corrective data for correcting a color of a subject image.

The feature value extracting section may extract the feature values including color information, from images of a same subject captured in different positions of the plurality of captured images captured by the image capturing apparatus.

The image processing system may further include: a corrective data storage section that stores a correspondence between the feature values extracted by the feature value extracting section and the corrective data; and a second feature value extracting section that extracts feature values respectively from images respectively captured in partial regions of a captured image captured by a second image capturing apparatus, where the image processing section reads from the corrective data storage section corrective data corresponding to the feature values extracted by the second feature value extracting section, and generates a corrected image in which the difference in optical response for each image region caused by an image capturing optical system of the second image capturing apparatus has been corrected.

According to a second aspect of the innovations herein, provided is an image processing method including: extracting feature values respectively from images captured in different positions of a plurality of captured images captured by an image capturing apparatus; calculating, from images of a same subject captured in different positions of the plurality of captured images captured by the image capturing apparatus, corrective data for correcting a difference in optical response for each image region caused by an image capturing optical system of the image capturing apparatus; and correcting, based on feature values respectively extracted from images captured in different positions of a captured image and by using the corrective data, the captured image for a difference in optical response for each image region caused by an image capturing optical system used in capturing the captured image, so as to generate a corrected image in which the difference in optical response for each image region caused by the image capturing optical system has been corrected.

According to a third aspect of the innovations herein, provided is a computer readable medium storing therein a program for an image processing system, the program causing a computer to function as: a feature value extracting section that extracts feature values respectively from images captured in different positions of a plurality of captured images captured by an image capturing apparatus; a corrective data calculating section that calculates, from images of a same subject captured in different positions of the plurality of captured images captured by the image capturing apparatus, corrective data for correcting a difference in optical response for each image region caused by an image capturing optical system of the image capturing apparatus; and an image processing section that, based on feature values respectively extracted from images captured in different positions of a captured image and by using the corrective data, corrects the captured image for a difference in optical response for each image region caused by an image capturing optical system used in capturing the captured image, so as to generate a corrected image in which the difference in optical response for each image region caused by the image capturing optical system has been corrected.

The summary of the invention does not necessarily describe all necessary features of the present invention. The present invention may also be a sub-combination of the features described above.

### BRIEF DESCRIPTION OF THE DRAWINGS

FIG. 1 shows an exemplary entire configuration of an image processing system 10 according to an embodiment.

FIG. 2 shows an exemplary block configuration of an image processing apparatus 170.

FIG. 3 shows an exemplary processing flow of the image processing apparatus 170.

### DESCRIPTION OF EXEMPLARY EMBODIMENTS

The invention will now be described based on the preferred embodiments, which do not intend to limit the scope of the present invention, but exemplify the invention. All of the features and the combinations thereof described in the embodiment are not necessarily essential to the invention.

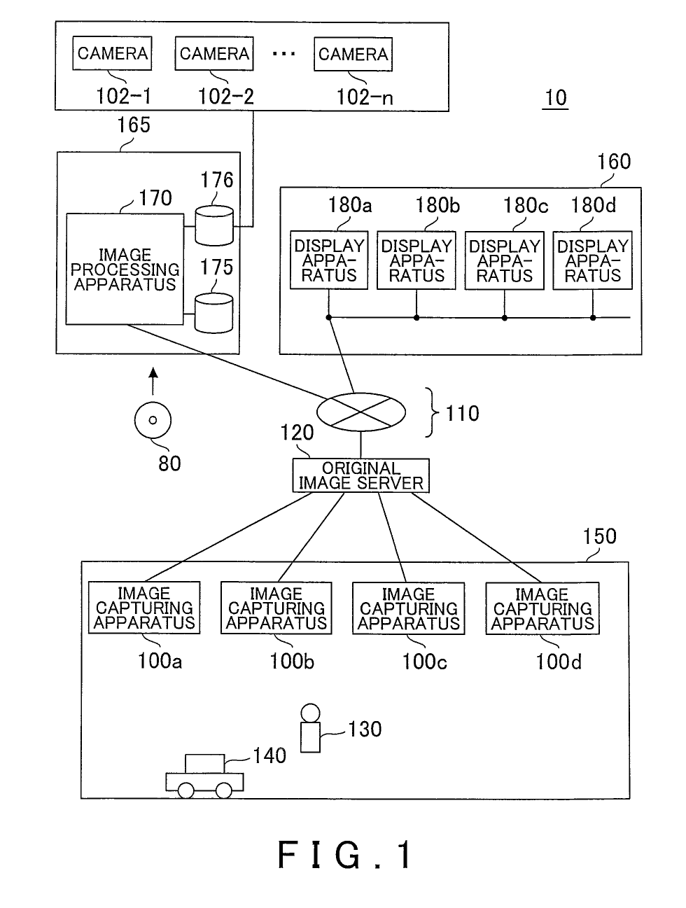

FIG. 1 shows an exemplary entire configuration of an image processing system 10 according to an embodiment. As explained below, the image processing system 10 can function as a video monitoring system. The image processing system 10 can also function as a system providing services for correcting image deterioration of the captured image caused by the image capturing optical system, not limited to the function as a video monitoring system.

The image processing system 10 includes a plurality of image capturing apparatuses 100a-d for capturing images of a monitor space 150, an original image server 120, a communication network 110, an image processing apparatus 170, an image database 175, a learning image database 176, and display apparatuses 180a-d.

In the following explanation, the image capturing apparatus 100a, the image capturing apparatus 100b, the image capturing apparatus 100c, and the image capturing apparatus 100d are occasionally collectively referred to as “image capturing apparatus 100.” This rule occasionally applies to the other reference signs including an alphabet at the end.

The image capturing apparatus 100a captures the image of the monitor space 150. The image capturing apparatus 100a captures the image of a moving body such as a person 130, a vehicle 140, and the like in the monitor space 150, to generate a moving image. The image capturing apparatus 100a supplies, to the original image server 120, the moving image obtained by capturing the image of the monitor space 150. The image capturing apparatuses 100b-d are provided in positions different from the image capturing apparatus 100a. Except for this point, the image capturing apparatuses 100b-d have the same function and operation as that of the image capturing apparatus 100a, and so are not detailed in the following.

The original image server 120 transmits the moving image supplied from the image capturing apparatuses 100a-d onto the communication network 110 to be transmitted to the image processing apparatus 170. An electric communication circuit such as the Internet is an example of the communication network 110. The original image server 120 is provided near the image capturing apparatus 100, for example. In other embodiments, the original image server 120 may be provided in the monitor space 150.

The original image server 120 controls the image capturing operation of the image capturing apparatus 100. For example, the original image server 120 controls on/off of the image capturing function, the image capturing rate, etc. of the image capturing apparatus 100. When the image capturing apparatus 100 can perform image capturing under varied image capturing conditions, the original image server 120 may control the image capturing condition of the image capturing apparatus 100.

For example, when the image capturing apparatus 100 can change the zoom value when capturing an image, the original image server 120 may control the zoom value of the image capturing apparatus 100. When the image capturing apparatus 100 can capture an image by changing the focus position, the original image server 120 may control the focus position of the image capturing apparatus 100. When the image capturing apparatus 100 can capture an image by changing the diaphragm value, the original image server 120 may control the diaphragm value of the image capturing apparatus 100. When the image capturing apparatus 100 can capture an image in varied image capturing directions, the original image server 120 may control the image capturing direction of the image capturing apparatus 100.

The image processing apparatus 170 is provided in a space 165 distant from the monitor space 150, for example, and obtains moving images respectively captured by the image capturing apparatus 100 from the original image server 120 via the communication network 110. The image processing apparatus 170 corrects the obtained moving images, to generate corrected moving images. The image processing apparatus 170 stores the corrected moving images in the image database 175. In response to a request of the display apparatus 180, the image processing apparatus 170 transmits, via a communication network 110, a corrected moving image stored in the image database 175, to the display apparatus 180 provided in a space 160 different from the monitor space 150 and the space 165.

The image processing apparatus 170 may transmit a corrected moving image to the display apparatus 180, without storing it in the image database 175. The image processing apparatus 170 may store a moving image received from the original image server 120 in the image database 175, without performing any image processing to it. When a corrected moving image is requested by the display apparatus 180, the image processing apparatus 170 may generate the corrected moving image by performing image processing on a moving image stored in the image database 175, and transmit the generated corrected moving image to the display apparatus 180.

The display apparatus 180 displays the corrected moving image obtained from the image processing apparatus 170. The display apparatus 180 may be provided in a space distant from a space in which the image processing apparatus 170 is provided. The display apparatus 180 may alternatively be provided near or in the monitor space 150.

The following explains the overview of the corrective processing in the image processing apparatus 170. The learning image database 176 stores a plurality of moving images captured by a camera 102. The image processing apparatus 170 extracts a subject in the substantially same image region in frame images obtained under substantially the same image capturing conditions (e.g., substantially the same focus, zoom, and diaphragm conditions) and by the same image capturing apparatus, from the moving images stored in the learning image database 176, extracts a plurality of feature values from the groups of images of the extracted subject, calculates the probability distribution in a multidimensional feature value space by learning, and associates the image feature value of each image region with the probability in the corresponding feature value space. The image processing apparatus 170 then extracts the same subject existing in different image regions from the frame images obtained under substantially the same image capturing condition and by the same image capturing apparatus, by extracting objects having similar shapes to each other, object tracking in the image, or the like, and selects, from the extracted images of the same subject, the image of the same subject near the center of the frame image as a correct image (OK image), so as to calculate, based on the relation between the correct image and the images of the same subject surrounding the correct image in the frame, corrective data for correcting the image for each image capturing condition of the image capturing optical system of the camera 102 and for each image region and to generate an image without image deterioration such as blurring, distortion, or color shift. The image processing apparatus 170 stores the calculated corrective data in association with the probability, in the feature value space, of the image feature value for each of the extracted regions.

The image processing apparatus 170 extracts feature values from each image region from the frame images included in the moving image provided by the original image server 120. The image processing apparatus 170 obtains stored corrective data and the probability of applying the corrective data, using the position in the feature value space represented by the extracted feature values, and generates a corrected moving image by correcting each frame image based on each piece of corrective data and the probability of applying the piece of corrective data.

In this way, the image processing apparatus 170 generates the corrected moving image based on the feature values extracted from the image of the subject captured in different image regions. Consequently, the image processing apparatus 170 can generate a corrected image from which the effect of the lens distortion or the like on the frame images is eliminated even when there are varied optical responses of the image capturing optical system of the image capturing apparatus 100.

A recording medium 80 stores therein a program for the image processing apparatus 170. The program stored in the recording medium 80 is provided to an electronic information processing apparatus such as a computer functioning as the image processing apparatus 170 according to the present embodiment. A CPU included in the computer operates according to the contents of the program, to control each part of the computer. The program executed by the CPU causes the computer to function as the image processing apparatus 170 explained with reference to the present drawing or the subsequent drawings.

Examples of the recording medium 80, other than CD-ROM, are an optical recording medium such as DVD or PD, a magnetooptical recording medium such as MO or MD, a magnetic recording medium such as a tape medium or a hard disk apparatus, a semiconductor memory, and a magnetic memory. The recording medium 80 may also be a recording apparatus such as a hard disk or a RAM provided in a server system connected through a dedicated communication network or the Internet.

The recording medium 80 may also record a program for a computer functioning as the other constituting element of the image processing system 10. The program may cause a computer to function as at least one of the original image server 120, the display apparatus 180, and the image capturing apparatus 100 described with reference to the present drawing and the subsequent drawings.

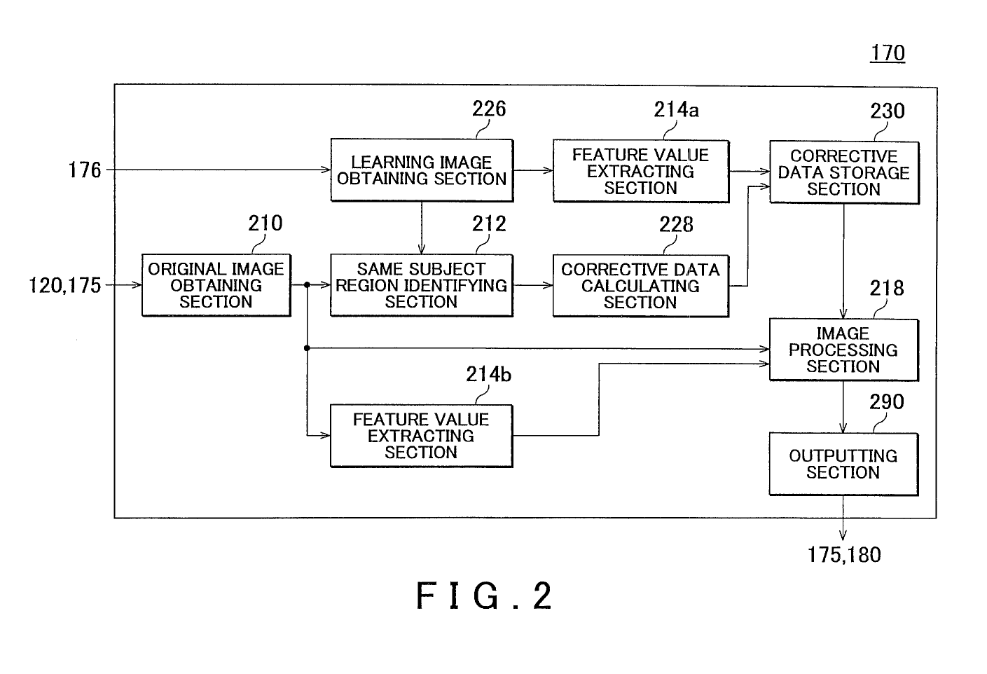

FIG. 2 shows an exemplary block configuration of the image processing apparatus 170. The image processing apparatus 170 includes an original image obtaining section 210, a same subject region identifying section 212, a feature value extracting section 214a, a feature value extracting section 214b, a learning image obtaining section 226, a corrective data calculating section 228, a corrective data storage section 230, an image processing section 218, and an outputting section 290.

The learning image database 176 obtains and stores a plurality of images captured by one or more cameras 102 different from the image capturing apparatus 100. Specifically, the camera 102 captures moving images captured under various image capturing conditions. The learning image database 176 obtains a plurality of images obtained by image-capturing of one or more cameras 102 under a plurality of respectively image capturing conditions. The moving images stored in the learning image database 176 are used for learning processing, and so are hereinafter referred to as learning moving image to be distinguished from the moving image(s) captured by the image capturing apparatus 100.

The following explains the learning operation of the image processing apparatus 170. The learning image obtaining section 226 obtains a moving image from the learning image database 176.

The same subject region identifying section 212 identifies a same subject region that is a region of the same subject captured at different positions of the image region, from a plurality of frame images included in the moving image obtained by the learning image obtaining section 226. For example, the same subject region identifying section 212 identifies the same subject region by extracting objects having similar shapes to each other. The same subject region identifying section 212 may identify the same subject region, by object tracking in the image by means of an optical flow method, a mean shift method, Kalman filtering, and the like. Note that the same subject region identifying section 212 identifies the same subject region from the plurality of frame images captured under the same image capturing condition.

For example, the same subject region identifying section 212 may search for similar image blocks between frames, calculate the velocity field of the images, and track the object of the same subject based on the velocity field, to identify the same subject region. The same subject region identifying section 212 may calculate the velocity field by calculating the spatiotemporal differential of the pixel value and track the object of the same subject based on the velocity field, to identify the same subject region.

Except for the above methods, the same subject region identifying section 212 may track the object of the same subject by searching between the frames for image regions having similar pixel value histograms to each other, to identify the same subject region. Here, the pixel value histogram may be a color histogram, a luminance histogram, and so on. The color histogram may be a color component histogram in the RGB color space, or may be a HSV color space histogram made of hue, saturation, and brightness. The same subject region identifying section 212 may estimate the future position of an object determined as the same subject based on the past position of the object, to track the object of the same subject.

Due to the lens distortion or the like, there are cases in which the objects of the same subject are extracted to have different shape information, color information, or the like, according to their positions in the image. On the other hand, the above-explained object tracking may enable appropriate identification of a same subject region even from images captured through a largely distorted lens, by incorporating change in shape information and color information as needed during tracking.

The same subject region identifying section 212 identifies the same subject region corresponding to each position of the frame. The same subject region identifying section 212 identifies a plurality of same subject regions, the same subjects captured therefrom having similar conditions on such as angle, shape, and illumination.

The feature value extracting section 214a normalizes the image capturing angle, illumination condition, and the like of each identified subject, before extracting the feature values from the images of the plurality of image regions. The feature values may for example include an edge component, a luminance value, a color component, and a spatial frequency component calculated based on values of a target pixel and its surrounding pixels on the image.

Note that the feature value extracting section 214a may extract the directional component and the intensity component of an edge, as the feature value of the edge component. In this case, the feature value extracting section 214a may extract the directional component and the intensity component of an edge for each color component, as the feature value of the edge component. The feature value extracting section 214a may extract at least one of the average of the luminance values and the luminance distribution of a plurality of pixels, as the feature value of the luminance value. The feature value extracting section 214a may also extract at least one of the average and the distribution of the plurality of pixels for each color component, as the feature value of the color component. The feature value extracting section 214a may extract the spatial frequency component for each predetermined space direction, or extract the spatial frequency component for each color, as the feature value of the spatial frequency components of a plurality of pixels. From the feature values extracted from adjacent partial regions, the feature value extracting section 214a may also calculate the gradient vector of the feature values between the partial regions or the difference of the feature values, and extract the gradient vector or the difference as the feature value.

The corrective data calculating section 228 calculates corrective data for correcting, using the relation of the images of the plurality of same subject regions, the images of the plurality of same subject regions identified by the same subject region identifying section 212, for the difference in optical response for each image region caused by the image capturing optical system of the camera 102 captured each of the images, using the image at the center of the frame as a correct image by integrating the relation of a plurality of subjects. For example, the corrective data calculating section 228 calculates the image filter operable to convert the image of the same subject region identified by the same subject region identifying section 212 into a correct image, by averaging the relation between a plurality of subjects.

The corrective data storage section 230 stores the corrective data calculated by the corrective data calculating section 228, in association with the probability distribution of the feature value calculated by the feature value extracting section 214 for each coordinates position of the image.

The following describes the corrective operation performed by the image processing apparatus 170. The original image obtaining section 210 obtains a moving image from the original image server 120. Note that the original image obtaining section 210 may obtain a moving image from the image database 175 as described above.

The feature value extracting section 214 may extract the feature values from the images of the plurality of regions captured at different positions of the image region, from the plurality of frame images included in the moving image obtained by the original image obtaining section 210, after normalizing the illumination condition from each of them. The feature values may for example include an edge component, a luminance value, a color component, and a spatial frequency component calculated based on values of a target pixel and its surrounding pixels on the image. Note that the feature value extracting section 214b may extract the feature values similar to the feature values extracted by the feature value extracting section 214a explained above. In this way, the feature value extracting section 214b extracts the feature values from the images of the plurality of regions captured at different positions on the plurality of frame images captured by the image capturing apparatus 100.

The image processing section 218 reads, from the corrective data storage section 230, the corrective data stored in association with the probability distribution of the feature value calculated by the feature value extracting section 214b.

The image processing section 218 uses the corrective data read from the corrective data storage section 230 to perform image processing to the moving image obtained by the image obtaining section 210. Accordingly, the image processing section 218 can generate a corrected image in which the difference in optical response according to each image region caused by the image capturing optical system of the image capturing apparatus 100 has been eliminated. In this way, the image processing section 218 generates the corrected image using corrective data associated with the feature value matching the feature value extracted from the feature value extracting section 214b.

The image processing section 218 supplies the corrected image to the outputting section 290. The outputting section 290 transmits the corrected image to the display apparatus 180. The outputting section 290 may store the corrected image in the image database 175.

As explained above, the image processing apparatus 170 can generate a filter by learning performed using the frame image captured by the camera 102 under various image capturing conditions. The image processing apparatus 170 can generate a corrected image using a filter corresponding to the feature value extracted from the image of the image region of the frame image captured by the image capturing apparatus 100. For this reason, even when the optical response of the image capturing optical system of the image capturing apparatus 100 is unknown, the resulting corrected image is free from the optical distortion of the image capturing optical system of the image capturing apparatus 100.

Therefore, the image capturing apparatus 100 can correct an image using the image processing apparatus 170, with high accuracy even without being equipped with a function of detecting a focus position, a zoom value, etc., thereby enabling to obtain a high quality image from which the optical distortion is eliminated inexpensively. The image capturing apparatus 100 can also use a cheaper image capturing optical system having low optical accuracy, to further reduce the cost.

The feature value extracting section 214a and the feature value extracting section 214b can function as a first feature value extracting section and a second feature value extracting section in the present invention. When the function of the feature value extracting section 214a and the feature value extracting section 214b is implemented in the same image processing apparatus 170, the feature value extracting section 214a and the feature value extracting section 214b may be implemented as the same functional block. In addition, the camera 102 and the image capturing apparatus 100 can function as a first image capturing apparatus and a second image capturing apparatus in the present invention. Note that the corrective data storage section 230 may store the corrective data calculated by the corrective data calculating section 228, in association with the information identifying the image capturing apparatus 100.

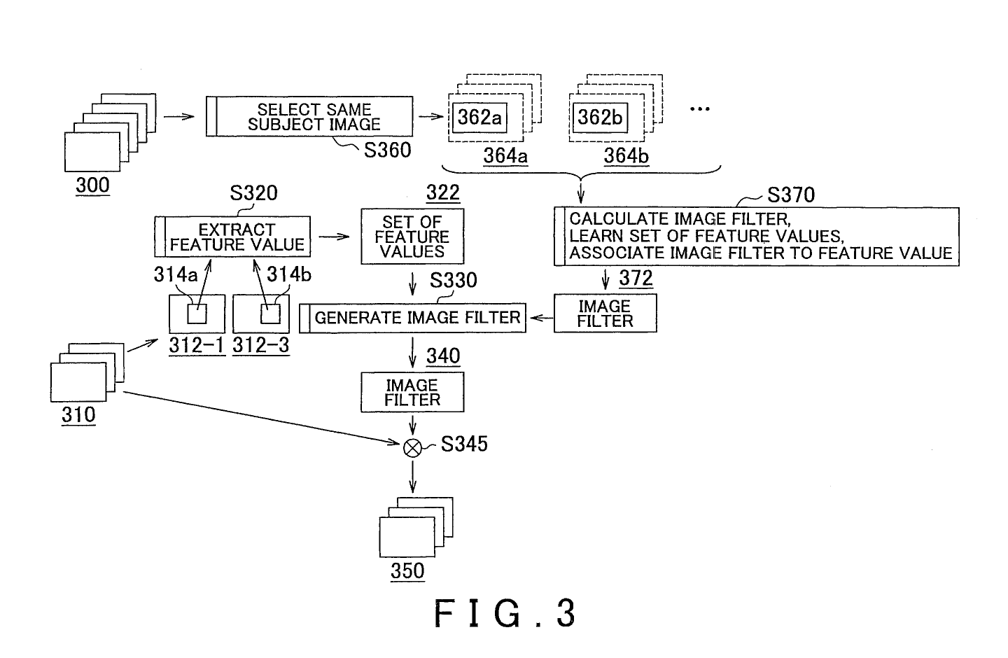

FIG. 3 shows an exemplary processing flow of the image processing apparatus 170. This drawing explains the processing of the image processing apparatus 170 to perform image processing on the moving image 310 captured by the image capturing apparatus 100a, to generate a corrected moving image 350.

Prior to the image processing on the moving image 310, an image filter is generated in the image processing apparatus 170. The learning image database 176 stores therein a learning moving image 300 captured by the camera 102. The same subject region identifying section 212 selects, from among the frame images included in the learning moving image 300 stored in the learning image database 176, subject images 362a, . . . 362b, . . . of the same object in different positions in the frame, which match at a degree of matching larger than a predetermined value (S360). In this operation, the learning image sets 364a, 364b, . . . for generating the image filter are extracted.

The corrective data calculating section 228 generates an image filter 372 from each of the learning image sets, by performing learning processing using the learning image sets 364a, 364b, . . . (S370). The generated image filter 372 is stored in the corrective data storage section 230 in association with the feature value.

The following explains the image processing performed on the moving image 310. The original image obtaining section 210 obtains a moving image 310 including a plurality of frame images 312. The feature value extracting section 214b extracts an image feature value based on the image of the image region 314 of the moving image 310 (S320), to extract a set of feature values 322.

The image processing section 218, based on the set of feature values 322, determines one or more image filters used in generating an image filter to be used to the moving image 310, together with the probability of the image filter being applied. The image processing section 218 generates an image filter 340 based on the determined image filters and the determined probability (S330).

The image processing section 218 uses an image filter 340 to filter the frame images included in the moving image 310 to generate a corrected moving image 350 (S345). The corrected moving image 350 is outputted by the outputting section 290 to the display apparatus 180 or to the image database 175.

In the above explanation, two same subject regions are identified to simplify the explanation. However, the number of the identified same subject regions may be three, for example. So as to detect the deformation of the image capturing optical system, it is desirable to identify as many same subject regions as possible, from the peripheral region, not only from the vicinity of the center of the image region. In this way, the image processing section 218 generates a corrected image based on the feature value extracted by the feature value extracting section 214a and the position of the same subject on the plurality of images, and so can occasionally generate an appropriate image filter 340 taking into consideration the distortion of the image capturing optical system.

An exemplary image filter is a filter for calculating the pixel value of a target pixel, by weighted average of the pixel values of the pixels surrounding the target pixel. Alternatively, the image filter may be a frequency filter for enhancing the higher frequencies such as edge enhancement, and a geometry filter for affine transformation. In this way, the corrective data may be an image filter to be applied to a subject image, and the image processing section 218 generates a corrected image by applying an image filter included in the corrective data to an image. The corrective data in the present invention may also be, other than the image filter, pixel data to be added to the frame image to be corrected or the spatial frequency component itself. In this way, the corrective data may include a high frequency component to be added to a subject image. The image processing section 218 may generate a corrected image by extracting the high frequency component from the corrective data for example by using a high pass filter, amplifying it, and adding it to the image.

The feature value extracting section 214b may extract an appropriate type of feature value, according to the contents to be corrected. For example, when the image processing section 218 generates a corrected image using corrective data for correcting the shape of a subject image, the feature value extracting section 214b may extract the feature value including edge information, from the images of the same subject captured in different positions on the plurality of images captured by the image capturing apparatus. When the image processing section 218 generates a corrected image using corrective data for correcting the blurring of a subject image, the feature value extracting section 214b may extract the feature value including the spatial frequency component, from the images of the same subject captured in different positions on the plurality of images captured by the image capturing apparatus.

In addition, the image processing section 218 may generate a corrected image by using corrective data for correcting the color of a subject image, and in this case, the feature value extracting section 214b extracts the feature value including the color information, from the images of the same subject captured in different positions on the plurality of images captured by the image capturing apparatus. The feature value including color information may be a color histogram, and a color spatial distribution, and so on.

The corrective data storage section 230 may store the image filter 340 calculated in S330, in association with information for identifying the image capturing apparatus 100a. The corrective data storage section 230 may correct a new frame image obtained from the image capturing apparatus 100a, using an image filter 340 stored in the corrective data storage section 230.

The image filter may also define processing to replace the pixel value of the target value, from the pixel values of the pixels surrounding the target pixel, to the value estimated by prior learning performed in advance.

Note that the corrective data calculating section 228 may desirably calculate the corrective data by performing learning at least using the plurality of images captured by one or more cameras 102 under a plurality of various image capturing conditions. In addition, the corrective data calculating section 228 may desirably calculate the corrective data by performing learning at least using the plurality of images of subjects different in position in the optical axial direction captured by one or more cameras 102.

Although some aspects of the present invention have been described by way of exemplary embodiments, it should be understood that those skilled in the art might make many changes and substitutions without departing from the spirit and the scope of the present invention which is defined only by the appended claims.

The operations, the processes, the steps, or the like in the apparatus, the system, the program, and the method described in the claims, the specification, and the drawings are not necessarily performed in the described order. The operations, the processes, the steps, or the like can be performed in an arbitrary order, unless the output of the former-described processing is used in the later processing. Even when expressions such as “First,” or “Next,” or the like are used to explain the operational flow in the claims, the specification, or the drawings, they are intended to facilitate the understanding of the invention, and are never intended to show that the described order is mandatory.

What is claimed is:

1. An image processing system comprising:
a feature value extracting section that extracts feature values respectively from images captured in different positions of a plurality of captured images captured by an image capturing apparatus;
a corrective data calculating section that calculates, from images of a same subject captured in different positions of the plurality of captured images captured by the image capturing apparatus, corrective data for correcting a difference in optical response for each image region caused by an image capturing optical system of the image capturing apparatus; and
an image processing section that, based on feature values respectively extracted from images captured in different positions of a captured image and by using the corrective data, corrects the captured image for a difference in optical response for each image region caused by an image capturing optical system used in capturing the captured image, so as to generate a corrected image in which the difference in optical response for each image region caused by the image capturing optical system has been corrected.

2. The image processing system according to claim 1, wherein
the image processing section corrects, based on the feature values respectively extracted by the feature value extracting section and by using the corrective data, a captured image captured by the image capturing apparatus for a difference in optical response for each image region caused by the image capturing optical system of the image capturing apparatus, so as to generate a corrected image in which the difference in optical response for each image region caused by the image capturing optical system of the image capturing apparatus has been corrected.

3. The image processing system according to claim 2, wherein
the image processing section generates the corrected image based on the feature values extracted by the feature value extracting section and a position of the same subject on the plurality of captured images.

4. The image processing system according to claim 3, further comprising:
a corrective data storage section that stores the corrective data in association with the feature values extracted from images captured in different positions, wherein
the image processing section generates the corrected image, by using the corrective data stored in the corrective data storage section in association with feature values matching the feature values extracted from the captured image captured by the image capturing apparatus.

5. The image processing system according to claim 4, wherein
the corrective data calculating section calculates corrective data for correcting a difference in optical response for each image region caused by an image capturing optical system of a different image capturing apparatus different from the image capturing apparatus, from images of a same subject captured in different positions of a plurality of captured images captured by the different image capturing apparatus, by using one of the images of the same subject as a correct image by giving higher priority to an image positioned nearer to a center of the captured images, and
the image processing section generates the corrected image, by using the corrective data stored in the corrective data storage section in association with the feature values matching the feature values extracted from the captured image captured by the image capturing apparatus.

6. The image processing system according to claim 5, wherein
the corrective data calculating section calculates the corrective data by performing processing at least using a plurality of captured images captured by the different image capturing apparatus under a plurality of respectively different image capturing conditions.

7. The image processing system according to claim 5, wherein
the corrective data calculating section calculates the corrective data by performing processing at least using a plurality of captured images of subjects having respectively different distances in an optical axial direction captured by the different image capturing apparatus.

8. The image processing system according to claim 3, wherein
the image processing section generates the corrected image by using the corrective data for correcting a shape of a subject image.

9. The image processing system according to claim 8, wherein
the feature value extracting section extracts the feature values including edge information, from images of a same subject captured in different positions of the plurality of captured images captured by the image capturing apparatus.

10. The image processing system according to claim 3, wherein
the image processing section generates the corrected image by using the corrective data for correcting blurring of a subject image.

11. The image processing system according to claim 10, wherein
the feature value extracting section extracts the feature values including a spatial frequency component, from images of a same subject captured in different positions of the plurality of captured images captured by the image capturing apparatus.

12. The image processing system according to claim 10, wherein
the corrective data includes a high frequency component to be added to the subject image, and
the image processing section generates the corrected image by adding, to an image, the high frequency component included in the corrective data.

13. The image processing system according to claim 10, wherein
the corrective data includes an image filter to be applied to the subject image, and
the image processing section generates the corrected image by applying, to an image, the image filter included in the corrective data.

14. The image processing system according to claim 3, wherein
the image processing section generates the corrected image by using the corrective data for correcting a color of a subject image.

15. The image processing system according to claim 14, wherein
the feature value extracting section extracts the feature values including color information, from images of a same subject captured in different positions of the plurality of captured images captured by the image capturing apparatus.

16. The image processing system according to claim 1, further comprising:
a corrective data storage section that stores a correspondence between the feature values extracted by the feature value extracting section and the corrective data; and
a second feature value extracting section that extracts feature values respectively from images respectively captured in partial regions of a captured image captured by a second image capturing apparatus, wherein
the image processing section reads from the corrective data storage section corrective data corresponding to the feature values extracted by the second feature value extracting section, and generates a corrected image in which the difference in optical response for each image region caused by an image capturing optical system of the second image capturing apparatus has been corrected.

17. An image processing method comprising:
extracting feature values respectively from images captured in different positions of a plurality of captured images captured by an image capturing apparatus;
calculating, from images of a same subject captured in different positions of the plurality of captured images captured by the image capturing apparatus, corrective data for correcting a difference in optical response for each image region caused by an image capturing optical system of the image capturing apparatus; and
correcting, based on feature values respectively extracted from images captured in different positions of a captured image and by using the corrective data, the captured image for a difference in optical response for each image region caused by an image capturing optical system used in capturing the captured image, so as to generate a corrected image in which the difference in optical response for each image region caused by the image capturing optical system has been corrected.

18. A computer readable medium storing therein a program for an image processing system, the program causing a computer to function as:
a feature value extracting section that extracts feature values respectively from images captured in different positions of a plurality of captured images captured by an image capturing apparatus;
a corrective data calculating section that calculates, from images of a same subject captured in different positions of the plurality of captured images captured by the image capturing apparatus, corrective data for correcting a difference in optical response for each image region caused by an image capturing optical system of the image capturing apparatus; and
an image processing section that, based on feature values respectively extracted from images captured in different positions of a captured image and by using the corrective data, corrects the captured image for a difference in optical response for each image region caused by an image capturing optical system used in capturing the captured image, so as to generate a corrected image in which the difference in optical response for each image region caused by the image capturing optical system has been corrected.
